(19) United States
(12) Patent Application Publication
(10) Pub. No.: US 2010/0325162 A1
(43) Pub. Date: Dec. 23, 2010

(54) METHOD FOR ANALYZING DEVELOPMENT DATA OF AIRPORT CITY

(75) Inventors: Kung-Jeng Wang, Taipei County (TW); Wan-Chung Hong, Taoyuan County (TW); Shin-Hua Chen, Taipei County (TW); Shih-Min Wang, Taipei County (TW); Cheng-Che Chiang, Taipei City (TW); Liany-Quan Chen, Tainan City (TW); Ya-Chi Huang, Taipei City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: National Taiwan University of Science and Technology, Taipei (TW)

(21) Appl. No.: 12/569,899

(22) Filed: Sep. 30, 2009

(30) Foreign Application Priority Data
Jun. 19, 2009 (TW) 98120727

(51) Int. Cl. G06F 17/30

(52) U.S. Cl. 707/792; 707/E17.045

(57) ABSTRACT

A method for analyzing development data of an airport city is provided. First, a construct collecting database including a plurality of construct classes is provided, wherein each of the construct classes is corresponding to at least one keyword. Then, a text analysis is executed to the development data of the airport city to divide the development data into a building phase and an operating phase, and a plurality of construct messages is respectively captured from the development data of the building phase and the development data of the operating phase according to the keywords in the construct collecting database. Next, each of the construct messages is linked to a corresponding object according to the corresponding construct class and an occurrence time of the construct message. Finally, relations between the objects are established according to a construct relation data.

### CROSS-REFERENCE TO RELATED APPLICATION

This application claims the priority benefit of Taiwan application serial no. 98120727, filed on Jun. 19, 2009. The entirety of the above-mentioned patent application is hereby incorporated by reference herein and made a part of specification.

### BACKGROUND OF THE INVENTION

1. Field of the Invention

The present invention generally relates to a method for analyzing data, and more particular, to a method for analyzing development data of an airport city.

2. Description of Related Art

Nowadays, most airports around the worlds are established and operated as airport cities and free trade zones. If those countries which are new to airport city can develop their own airport cities by referring to the successful experiences of other countries, the related industries and economics of these countries will be greatly facilitated. For example, an airport city can be planned and developed according to the development emphasis, features, and innovative operation modes of other airport cities.

However, the development mode of the entire industry and the related research and execution of airport management are not presently taken into consideration. Thereby, the efficiency in analyzing different aspects of airport development can be improved if the relations and interactions between these aspects can be provided.

### SUMMARY OF THE INVENTION

Accordingly, the present invention is directed to a method for analyzing development data of an airport city, wherein the development data of the airport city can be effectively analyzed and constructed.

The present invention provides a method for analyzing development data of an airport city. First, a construct collecting database is provided for collecting the development data of the airport city, wherein the construct collecting database includes a plurality of construct classes, and each of the construct classes is corresponding to at least one keyword. Then, a text analysis is respectively executed to the development data of a plurality of airports according to the collected data (data in the database can be added anytime), so as to divide the development data into a building phase and an operating phase, and a plurality of construct messages is respectively captured from the development data of the building phase and the development data of the operating phase according to the keywords in the construct collecting database, wherein each of the construct messages with occurrence time and is corresponding to one of the construct classes. Next, each of the construct messages is linked to a corresponding object according to the corresponding construct class and the occurrence time of the construct message, wherein the object is established into the building phase and the operating phase as a time dimension and the construct classes as an object dimension. Finally, relations between the objects are established according to a construct relation data, wherein the construct relation data records the relations between the construct classes.

According to an embodiment of the present invention, each of the construct messages includes a primary message and a plurality of secondary messages.

According to an embodiment of the present invention, after the construct messages are linked to the corresponding objects, the primary messages of the construct messages are displayed in an analysis table, and the secondary messages thereof are hidden.

According to an embodiment of the present invention, the step of displaying the primary messages of the construct messages in the analysis table includes following steps. First, the analysis table of each airport is established, wherein the analysis table is composed of a time dimension and an object dimension. Next, the primary messages are captured from the corresponding construct messages linked with the objects, and the primary messages are filled into the cells of the analysis table with the corresponding time dimension and object dimension.

According to an embodiment of the present invention, after the primary messages of the construct messages are displayed in the analysis table, one of the construct classes is selected according to a user's choice, and the objects corresponding to the selected construct class is selected from each of the airports.

According to an embodiment of the present invention, the method for analyzing the development data of the airport city further includes following steps. First, a comparison table is provided, wherein the format of the comparison table includes 2 types: one for first column (the building phase) and the other for second column (operating phase) respectively and a plurality of rows corresponding to the construct classes in each format, and the first column or the second column, and the rows form a plurality of cells. Next, the construct messages in the building phase are filled into the cells of comparison table corresponding to the building phase according to the construct classes thereof, and meanwhile, the construct messages in the operating phase are filled into the cells of comparison table corresponding to the operating phase according to the construct classes thereof.

According to an embodiment of the present invention, the construct classes include strategic planning, legal framework organizational development, financing, land development, introduced industry, and operation means.

As described above, in the present invention, the range of construct messages captured from a development data is determined according to a plurality of construct classes, so that less useless data will be captured. In addition, the construct messages are linked to the corresponding objects according to the occurrence time thereof and the corresponding construct classes, so that the desired data can be understood according to the relations and the structure between the objects. Moreover, according to the present invention, the development data of the same dimensions and constructs but different airport cities can be displayed in a comparison table so that a user can understand the similarities and dissimilarities of different airport cities and determine the user's own strategy accordingly.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flowchart of a method for analyzing the development data of an airport city according to an embodiment of the present invention.

FIG. 2 is a diagram of a comparison table according to an embodiment of the present invention.

FIG. 3 is a diagram of a construct relationship according to an embodiment of the present invention.

FIG. 4 is a diagram of an analysis table according to an embodiment of the present invention.

FIG. 5 is a diagram illustrating how development data of multiple airport cities is displaying in comparison table according to an embodiment of the present invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

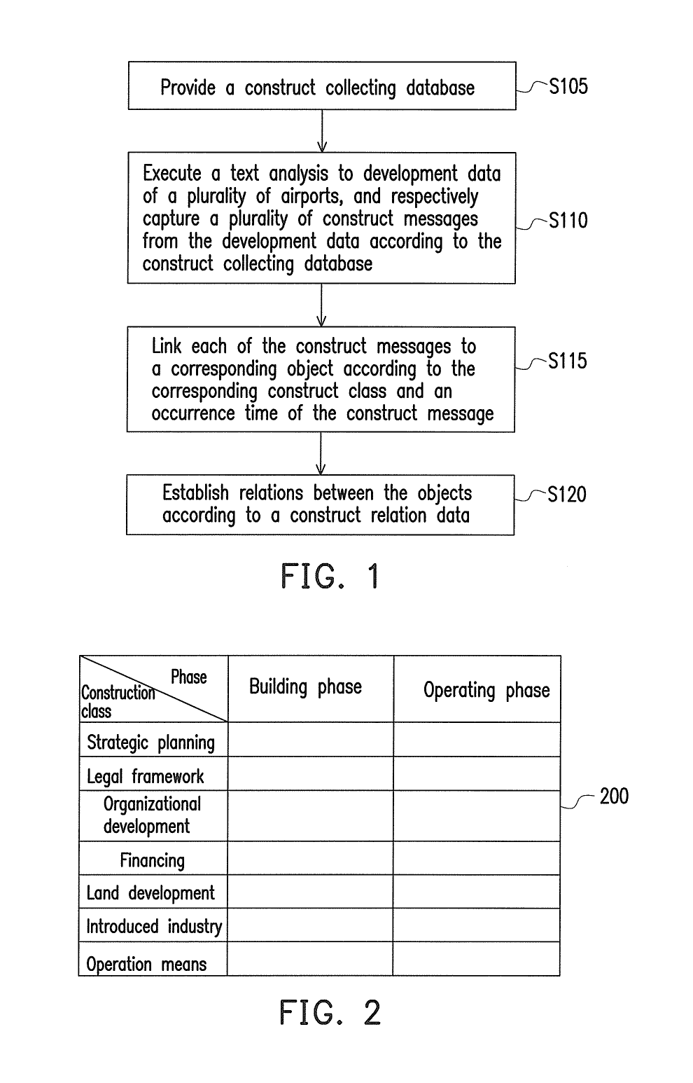

FIG. 1 is a flowchart of a method for analyzing the development data of an airport city according to an embodiment of the present invention. Referring to FIG. 1, first, in step S105, a construct collecting database is provided, wherein the construct collecting database includes a plurality of construct classes, and each of the construct classes is corresponding to at least one keyword. The construct classes include strategic planning, legal framework, organizational development, financing, land development, introduced industry, and operation means, etc. The data capturing range for airport city development can be determined specifically according to these construct classes.

For example, the keywords of strategic planning may be plan, strategy, and synonyms thereof, the keywords of legal framework may be rule, bylaw, law, and synonyms thereof, the keywords of organizational development may be the names (titles) of governments, organizations, and consortia, the keywords of financing may be amount and names of different currencies, the keywords of land development may be project, part, center, and synonyms thereof, the keywords of introduced industry may be industry, enterprise, and synonyms thereof, and the keywords of operation means may be establish, expand, start-up, and synonyms thereof. However, foregoing keywords are only some examples but not intended to limit the present invention.

Next, in step S110, a text analysis is respectively executed to the development data of a plurality of airports collected in previous step, and construct messages of the corresponding construct classes are captured from the development data, for example, wherein the text analysis may be executed through data mining. To be specific, the development data is first divided into a building phase and an operating phase through the text analysis. For example, generally speaking, when an airport enters from the building phase into the operating phase, which means the terminal of the airport has been officially put into operation, the development data can be divided into the building phase and the operating phase according to the date on which the terminal is put into operation. After that, a plurality of construct messages is respectively captured from the development data of the building phase and the development data of the operating phase according to the keywords in the construct collecting database. Because the construct messages are captured according to the keywords, each of the construct messages belongs to one of the construct classes. Herein each of the construct messages should include a simple text description and an occurrence time (for example, a year).

It should be mentioned that in the present embodiment, a comparison table may be further provided for displaying the construct messages. FIG. 2 is a diagram of a comparison table according to an embodiment of the present invention. Referring to FIG. 2, the comparison table 200 includes two columns respectively corresponding to the building phase and the operating phase and a plurality of rows respectively corresponding to the construct classes, wherein the columns and the rows form a plurality of cells. After the construct messages are captured from the development data, the construct messages of the building phase are filled into the cells corresponding to the building phase, and meanwhile, the construct messages of the operating phase are filled into the cells corresponding to the operating phase.

Thereafter, in step S115, the construct messages are linked to the corresponding objects according to the corresponding construct classes and occurrence time of the construct messages, wherein the objects are established based on the building phase and the operating phase as a time dimension and the construct classes as an object dimension. The construct messages are linked to the related objects according to different phases and the occurrence time thereof.

Finally, in step S120, relations between the objects are established according to a construct relation data, wherein the construct relation data records the relations between the construct classes. The construct relation data will be described below with an example.

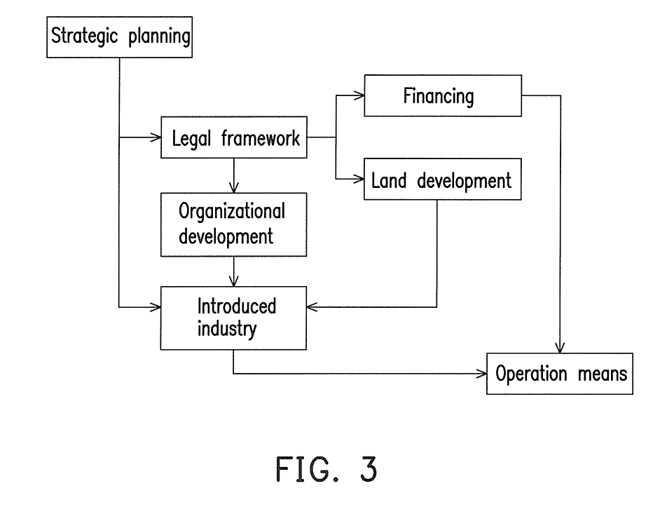

FIG. 3 is a diagram of a construct relation data according to an embodiment of the present invention. In the present embodiment, for the convenience of description, the construct relation data presents the connection relationship between the construct classes as a relational graph. Referring to FIG. 3, in the present embodiment, 8 construct classes are provided, and the connection relationship between these construct classes are denoted by the arrows. The strategic planning points to the legal framework and the introduced industry, the legal framework points to the financing, the land development, and organizational development, and so on. The construct classes may also present different meaning of relations according to the actual situation.

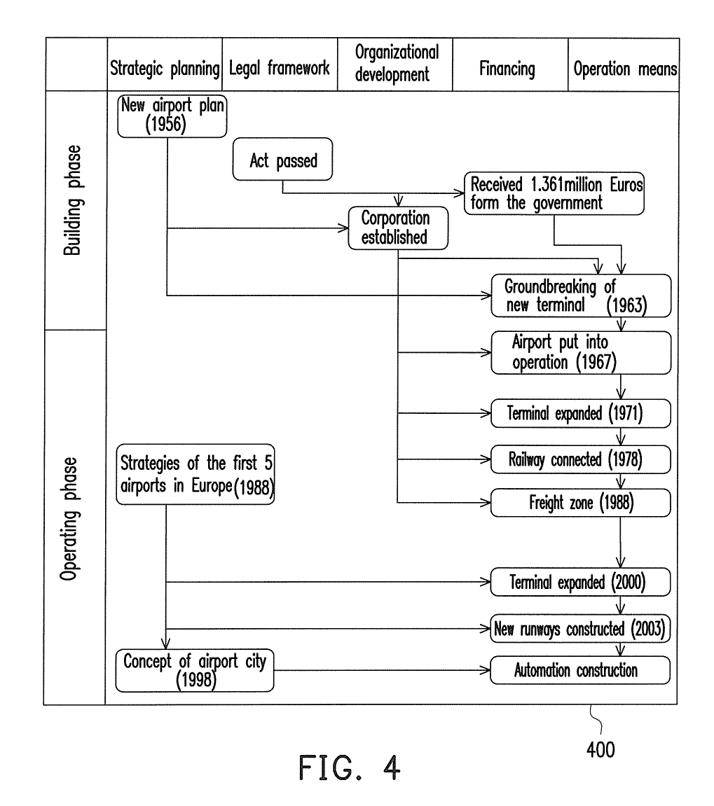

It should be noted that these objects may also be displayed in an analysis table to present the construct messages. In the present embodiment, the analysis table 400 is corresponding to the development data of one airport. In other words, the construct messages of different airports are respectively displayed in different analysis tables. FIG. 4 is a diagram of an analysis table according to an embodiment of the present invention. Referring to FIG. 4, the analysis table 400 is composed of a time dimension and an object dimension. The time dimension is in the vertical direction, and which is established with the building phase in front of the operating phase. The object dimension is in the horizontal direction, and which is established according to the construct classes. The present embodiment is described only with the construct classes of strategic planning, legal framework, organizational development, financing, and operation means. However, the scope of the construct classes is not limited in the present embodiment of invention.

Herein the object dimension and the time dimension form a plurality of objects, and the construct messages are filled into the corresponding objects according to the occurrence time thereof. For example, regarding the construct message of “concept of airport city (a primary message)”, the occurrence time thereof is year 1998, and this construct message belongs to the construct class of “strategic planning” and is the data in the operating phase. Thus, the construct message of “concept of the airport city” is filled into the object corresponding to the construct class “strategic planning” according to the occurrence time thereof.

Additionally, in the present embodiment, each of the construct messages includes a primary message and a plurality of secondary messages. In the analysis table 400, the secondary messages are hidden and only the primary messages of the construct messages are displayed so that the data displayed in the analysis table remains manageable.

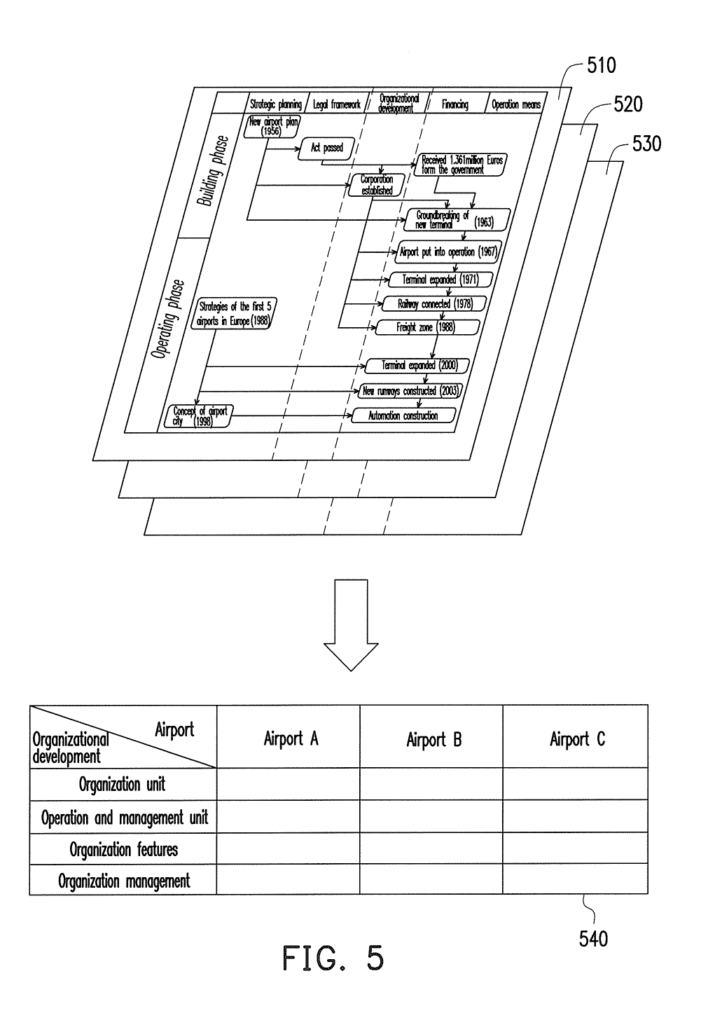

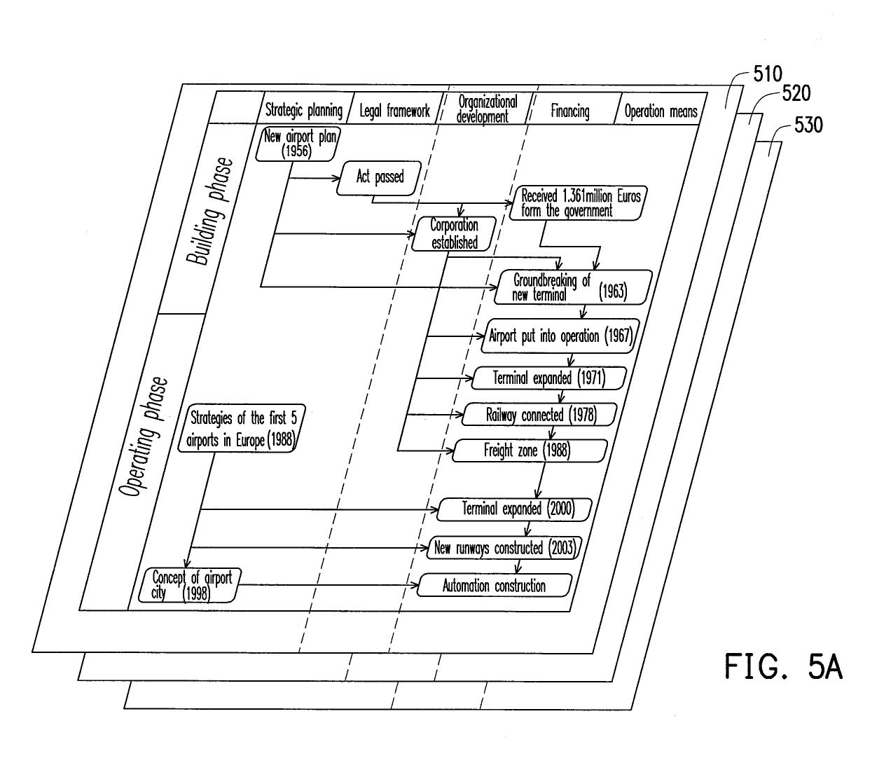

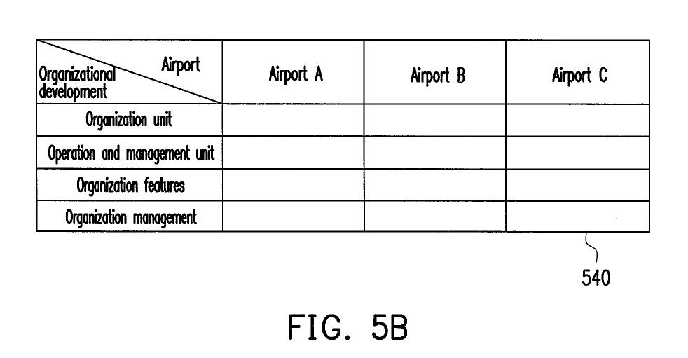

After displaying the primary messages of the construct messages in the analysis table, one of the construct classes is selected according to a user selection, and an object corresponding to the selected construct class is selected from the objects in the analysis table of each airport. FIG. 5 is a diagram illustrating how development data of multiple airport cities is gathered and compared into one comparison table according to an embodiment of the present invention. Referring to FIG. 5, the analysis tables 510, 520, and 530 are respectively corresponding to the airport A, the airport B, and the airport C. When a user is about to read the detailed analysis of one of the construct classes, the user may click one construct class (for example, the organizational development) in the analysis table 510. Then, the primary and secondary messages of the same construct class are captured and displayed side by side in all the analysis tables, so that the user can figure out and compare the data conveniently.

In the present embodiment, assuming the construct class selected by the user is the organizational development, as shown in the comparison table 540, the secondary messages corresponding to the organizational development of the airport A, the airport B, and the airport C are respectively listed. These secondary messages include organization unit, operation and management unit, organization features, and organization management.

It should be noted that multiple construct classes may be selected to be compared. For example, the construct classes of both the organizational development and the financing are selected, and the secondary messages of the organizational development and the financing are captured form the analysis tables of all the airports to be compared.

In overview, in the embodiments described above, a plurality of construct classes is defined for collecting the development data of an airport city, and construct messages are captured from the development data according to the construct classes. Then, the construct messages are linked to corresponding objects. Accordingly, the content of the desired data can be displayed to a user according to the relations and structures between the objects. In addition, less unsuitable data is captured by defining the construct classes in advance. Moreover, the development data to be analyzed can be effectively and instantly understood by the user through the help of the analysis tables.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for analyzing development data of an airport city, comprising:
providing a construct collecting database, wherein the construct collecting database comprises a plurality of construct classes, and each of the construct classes is corresponding to at least one keyword;
respectively executing a text analysis to the development data of a plurality of different airports to divide the development data into data of a building phase and data of a operating phase, and respectively capturing a plurality of construct messages from the data of the building phase and the data of the operating phase according to the keywords, wherein each of the construct message comprises an occurrence time and related information of the corresponding construct class;
linking each of the construct messages to a corresponding object according to the corresponding construct class and the occurrence time of the construct message, wherein the object is established with the building phase and the operating phase as a time dimension and the construct classes as an object dimension, the time dimension is in a vertical direction, and the object dimension is in a horizontal direction; and
establishing relations between the objects according to a construct relation data, wherein the construct relation data records relationship between the construct classes.

2. The method according to claim 1, wherein each of the construct messages comprises a primary message and a plurality of secondary messages.

3. The method according to claim 2, wherein after the step of linking the construct messages to the corresponding objects, the method comprises:
displaying the primary messages of the construct messages in an analysis table and hiding the secondary messages.

4. The method according to claim 3, wherein the step of displaying the primary messages of the construct messages in the analysis table comprises:
establishing the analysis table of each of the airports, wherein the analysis table is established with the time dimension and the object dimension; and
capturing the primary message from the construct message linked to each of the objects, and filling the primary message into a cell of the analysis table with the corresponding time dimension and the corresponding object dimension.

5. The method according to claim 1, wherein after displaying the primary messages of the construct messages in the analysis table, the method further comprises:
selecting one of the construct classes according to a user selection; and
respectively selecting the object corresponding to the selected construct class from each of the airports.

6. The method according to claim 1 further comprising:
providing a comparison table, wherein the comparison table comprises a first column and a second column respectively corresponding to the building phase and the operating phase and a plurality of rows respectively corresponding to the construct classes, and the first column, the second column, and the rows form a plurality of cells; and
filling the construct messages of the building phase into the cells corresponding to the building phase according to the construct classes, and meanwhile, filling the construct messages of the operating phase into the cells corresponding to the operating phase according to the construct classes.

7. The method according to claim 1, wherein the construct classes comprise strategic planning, legal framework, organizational development, financing, land development, introduced industry, and operation means.
